(19) United States
(12) Patent Application Publication
(10) Pub. No.: US 2008/0035679 A1
(43) Pub. Date: Feb. 14, 2008

(54) Fastening Device, Dispensing Assembly Comprising Such A Device, Dispenser Comprising Such An Assembly And Method Of Assembling Such A Dispenser

(76) Inventors: Herve Lompech, Bouttencourt (FR); Didier Roger Blondel, Criel Sur Mer (FR)

Correspondence Address: ST. ONGE STEWARD JOHNSTON & REENS, LLC, 986 BEDFORD STREET, STAMFORD, CT, 06905-5619, US

(21) Appl. No.: 11/561,744

(22) Filed: Nov. 20, 2006

(30) Foreign Application Priority Data
Aug. 9, 2006 (FR) FR 0607240

(51) Int. Cl. G01F 11/00

(52) U.S. Cl. 222/321.9

(57) ABSTRACT

Fastening device including a fastening sleeve including a plate, a skirt which has an intermediate portion including internal and external surfaces, and an end portion including internal and external surfaces, the end portion being movable between a free state, in which the external surface of the end portion projects towards the outside in relation to the external surface of the intermediate portion, and a deformed state, in which the internal surface of the end portion projects towards the inside in relation to the internal surface of the intermediate portion, a retaining ring. The fastening sleeve includes a crown having an external surface which is in axial alignment with the external surface of the intermediate portion of the skirt.

### CROSS-REFERENCE TO RELATED APPLICATIONS

The present application claims priority of French Patent Application No. 06 07240 filed Aug. 9, 2006, the content of which is incorporated herein by reference.

### FIELD OF THE INVENTION

The invention relates to a fastening device, a dispensing assembly comprising such a device, a dispenser comprising such an assembly and a method of assembling such a dispenser.

More specifically, the invention relates to a fastening device for fastening a dispensing device on a container comprising a tubular neck. The fastening device comprises a fastening sleeve comprising an annular plate centred on a central axis and extending along a radial plane in relation to the central axis, an annular skirt which extends axially from the plate, centred on the central axis, and which has a cylindrical intermediate portion adjacent to the plate and an end portion remote from the plate, said intermediate portion having an internal surface and an external surface, said end portion comprising an internal surface and an external surface, said end portion being movable between a free state, in which the external surface of said end portion projects towards the outside in relation to the external surface of the intermediate portion, and the internal surface of said end portion does not project towards the inside in relation to the internal surface of the intermediate portion, and a deformed state, in which the internal surface of said end portion projects towards the inside in relation to the internal surface of the intermediate portion, and the external surface of said end portion is in axial alignment with the external surface of the intermediate portion, a retaining ring adapted to entirely accommodate the fastening sleeve and having an internal surface adapted to be press fitted with friction on the external surface of the intermediate portion of the skirt.

### BACKGROUND OF THE INVENTION

A fastening device of this type may be utilized in particular for fastening a device for the dispensing of a fluid product, for example a pump or a valve, to the neck which extends along a longitudinal axis and of which a free end is provided with a rim projecting radially in relation to the longitudinal axis.

For example, the document U.S. Pat. No. 4,773,553 describes a sleeve dimensioned to receive a rim of a container and to be covered by a ring. The end portion of the sleeve is situated in the path of the displacement of the ring and is deformed radially towards the inside beneath the rim in order to secure the sleeve to the rim.

### SUMMARY OF THE INVENTION

The invention aims to improve the guiding of the ring at the time of its displacement on the sleeve, as well as the retention of the ring on the sleeve when the ring covers the sleeve.

For this purpose, the invention proposes a fastening device of the aforementioned type, wherein the fastening sleeve further comprises a crown which extends axially from the plate opposite the skirt, said crown having an external surface that is in axial alignment with the external surface of the intermediate portion of the skirt.

The crown, on the external surface of which the retaining ring may be press fitted with friction, thus permits the retaining ring to be positioned partially, in an appropriate manner, on the fastening sleeve. The external surface of the crown also permits the extent of the surfaces in contact between the retaining ring and the fastening sleeve to be increased, thereby ensuring satisfactory guiding of the ring at the time of its press fitting on the fastening sleeve and improving the retention of the retaining ring on the fastening sleeve.

In particular embodiments, the fastening device may have, where appropriate in a complementary manner, one or a plurality of the following arrangements:
the plate has a lower surface which comprises a support zone, situated centrally, and a centring zone, situated peripherally, linking said support zone to the internal surface of the intermediate portion of the skirt, said centring zone being flared from said lower surface toward said internal surface of the intermediate portion: with the end portion in the free state, the centring zone permits the achievement of suitable positioning and orientation of the fastening sleeve when it is arranged on the rim in order to permit the easy press fitting of the retaining ring.
the fastening device comprises at least one projection which extends substantially perpendicularly from the internal surface of the retaining ring, and which is adapted to enable engagement with the external surface of the intermediate portion of the skirt,
the crown comprises a free end having an external chamfer: this arrangement makes it possible to facilitate the engagement of the retaining ring on the crown of the fastening sleeve,

the fastening device is globally cylindrical of revolution about the central axis.

Moreover, an object of the invention is a dispensing assembly comprising a fastening device as defined above and a dispensing device, the annular plate delimiting an opening centred on the central axis, and into which the dispensing device is mounted so as to extend substantially along the central axis.

In particular embodiments, the dispensing assembly may have, where appropriate in a complementary manner, one or a plurality of the following arrangements:
the retaining ring is partially press fitted with friction on the external surface of the crown, above the end portion of the skirt, said end portion being in the free state,
the fastening sleeve comprises an annular internal wall which extends axially from the plate and which is adapted to receive the dispensing device with a fitting engagement,
the dispensing device comprises a cylindrical body extending along an axis and provided with a radial flange in relation to the axis of the body, the annular plate resting on the flange.

Furthermore, the invention proposes a dispenser comprising a dispensing assembly as above described and a container, which container comprises a tubular neck extending along a longitudinal axis, of which a free end is provided with a rim projecting radially in relation to the longitudinal axis, which neck is adapted to enable the dispensing device to extend into the neck, the skirt of the fastening sleeve being adapted to entirely accommodate the rim, and, in the deformed state of the end portion of the skirt, to enable at least one part of said end portion to be arranged beneath the rim.

In particular embodiments, the dispenser may have, where appropriate in a complementary manner, one or a plurality of the following arrangements:
the internal surface of the intermediate portion of the skirt has a dimension, measured radially in relation to the central axis of the fastening sleeve, that is greater than a maximum external dimension of the rim, measured radially in relation to the longitudinal axis: the risks of arranging the fastening sleeve in an inappropriate orientation, which could involve jamming, in particular by trapping the fastening sleeve on the rim or deformation of the fastening sleeve preventing the press fitting of the retaining ring, are reduced,
the neck is adapted to enable the dispensing device to be press fitted with friction into the neck,
the dispensing device extends into the neck, the plate resting on the rim, the skirt entirely accommodating the rim, the retaining ring entirely accommodating the fastening sleeve, the end portion of the skirt being in the deformed state so that at least one part of said end portion is arranged beneath the rim.

The invention also proposes a method of assembling a dispenser as defined above, said method providing for the following steps, starting from a container comprising a tubular neck extending along a longitudinal axis, of which a free end is provided with a rim projecting radially in relation to the longitudinal axis, and from a dispensing assembly as defined above:
position the dispensing assembly on the neck so that the central axis of the fastening sleeve extends substantially coaxially with the longitudinal axis of the neck, the dispensing device extending into the neck, the plate resting on the rim, the skirt entirely accommodating the rim, the retaining ring being partially press fitted with friction on the external surface of the crown, above the end portion of the skirt, said end portion being in the free state,
exert an external force on the retaining ring along the longitudinal axis, toward the neck, so as to displace the retaining ring in relation to the fastening sleeve until said retaining ring entirely accommodates said fastening sleeve, the retaining ring causing the end portion of the skirt to pass from the free state to the deformed state.

### BRIEF DESCRIPTION OF THE DRAWINGS

Other objects and advantages of the invention will be appreciated from reading the following description, with reference to the accompanying drawings, in which:

FIG. 1 is a representation in partial longitudinal section of a dispensing assembly comprising a fastening device according to an embodiment of the invention and a dispensing device, the fastening device comprising a fastening sleeve, an end portion of which is in a free state,

FIG. 2 is a representation in partial longitudinal section of a dispenser comprising the dispensing assembly depicted in FIG. 1 mounted on a neck of a container, the end portion being in a deformed state,

FIG. 3 is a representation similar to that of FIG. 2, in which the dispensing device is actuated.

### DETAILED DESCRIPTION OF THE INVENTION

In the figures, the same references designate identical or similar elements.

The figures represent a dispenser 1 comprising a container 3, within which a fluid product to dispense is placed. The fluid product may be, for example, a liquid product of the pharmaceutical, cosmetics, perfumery or other field.

The container 3 may comprise a bottom and a generally cylindrical wall which extends around a longitudinal axis 4 perpendicular to the bottom. The container 3 comprises a tubular neck 6, which may extend opposite the bottom substantially coaxially with the axis 4 of the container 3. The neck 6 delimits an opening 5 and has a free end provided with a rim 2 projecting radially in relation to the longitudinal axis 4. In the figures, provision is made for the rim 2 to have an upper surface provided with an annular ring 14 projecting from said upper surface.

The dispenser also comprises a dispensing device 7 mounted into the opening 5 of the neck 6 and adapted to pick up the fluid product from the container 3 and to deliver it to the outside.

In the following description, the terms “bottom” or “lower” and “top” or “upper” are understood in relation to the orientation of the container 3 resting on the bottom. Moreover, the terms “inside”, “interior” or “internal” and “outside”, “exterior” or “external” make reference to planes running parallel to the longitudinal axis 4 and situated respectively in proximity to and at a distance from the longitudinal axis 4.

In particular examples, the dispensing device 7 may constitute a device capable of manual actuation permitting the dispensing of the fluid product, in particular by spraying, i.e. in the form of an aerosol comprising individual droplets.

The dispensing device 7 may comprise a cylindrical body 8 extending along an axis, hollow and comprising an open lower end and an open upper end, in the vicinity of which an annular flange 15 extends radially towards the outside in relation to the axis of the body 8.

A stem 10 assembled in the open upper end of the body 8 is movable in part inside the body 8 in translation along the axis of the body.

At the open lower end, the body 8 may, where appropriate, have a tubular fastening wall 11 receiving a dip tube 12 with a press fitting engagement. The lower free end of the dip tube 12 may rest in proximity to the bottom of the container 3 so as to bring the stem 10, of which the upper end projects from the opening 5 of the container 3, into fluid communication with the container 3. The stem 10 may thus deliver the fluid product. An actuator 9, where appropriate provided with an outlet nozzle 13, may be assembled on the upper end of the stem 10.

The dispensing device 7 may be a valve assembled on the pressurized container 3, and wherein the stem 10 comprises at least one closable orifice capable of being brought into fluid communication with the inside of the body 8. As a variant, the dispensing device 7 may be a pump comprising a compression chamber delimited by an inlet valve in proximity to the lower end of the body 8 and a piston mounted on the base of the stem 10 and movable in a tightly sealed manner inside the body 8.

The dispensing device 7 may be assembled on the neck 6 of the container 3 so as to extend into the neck 6 coaxially with the longitudinal axis 4.

In the embodiment represented in FIGS. 2 and 3, the flange 15 is provided in order to be capable of resting on the upper surface of the rim 2 by being surrounded by the ring 14. Furthermore, the neck 6 of the container 3 and the body 8 of the dispensing device may have dimensions measured radially in relation to the longitudinal axis 4 such that the dispensing device 7 is press fitted with very weak radial clearance into the neck 6. This embodiment makes it possible to ensure, at least partially, the maintaining of the dispensing device 7 into the neck 6 and sealing between the dispensing device 7 and the neck 6.

In order to fasten the dispensing device to the neck 6 of the container 3, the use of a fastening device comprising a fastening sleeve 20 and a retaining ring 21 is provided. The fastening sleeve 20 is in particular intended to associate the dispensing device 7 with the neck 6 of the container 3. The retaining ring 21 is intended to maintain the fastening sleeve in a state in which it associates the dispensing device 7 with the neck 6 of the container 3.

In a particular example, it may be provided that the neck 6 of the container 3 and the rim 2 are cylindrical of revolution about the longitudinal axis 4, so as respectively to have sections that are substantially circular. Provision is thus made in the same manner for the fastening device to be globally cylindrical of revolution about a central axis 22. The dimensions measured radially in relation to the longitudinal axis 4 and the central axis 22 may thus correspond to diameters.

The fastening sleeve 20 may be made of a deformable material and comprises an annular plate 25 centred on the central axis 22 and extending along a radial plane in relation to the central axis 22, an annular skirt 26 which extends axially, i.e. along the central axis 22, from the plate 25, for example from the outer edge of the plate 25, centred on the central axis 22, and a crown 27 which extends axially from the plate 25 opposite the skirt 26.

In particular, in the figures, the plate 25 may comprise an annular internal wall 28 which extends axially from the internal edge of the plate 25 by delimiting an opening 29 centred on the central axis 22. The plate 25 may, in particular, have a lower surface which comprises a support zone 25a, situated centrally, and a centring zone 25b, situated peripherally, which is flared from the lower surface.

The skirt 26 has a cylindrical intermediate portion 26a adjacent to the plate 25 and an end portion 26b remote from the plate 25. The skirt 26 may be circumferentially continuous or may have a succession of slots extending along the longitudinal axis 4 in the intermediate portion 26a and in the end portion 26b and delimiting a plurality of longitudinal feet.

The intermediate portion 26a has an external surface and an internal surface. In the example, given the symmetry of revolution, provision may be made for the internal surface of the intermediate portion 26a to have a substantially constant internal diameter, and for the external surface of the intermediate portion 26a to have a substantially constant external diameter. The internal surface of the intermediate portion 26a may be linked to the support zone 25a of the plate 25 by the centring zone 25b. The centring zone 25b may then be inclined by being widened out from the support zone 25a towards the internal surface of the intermediate portion 26a of the skirt 26.

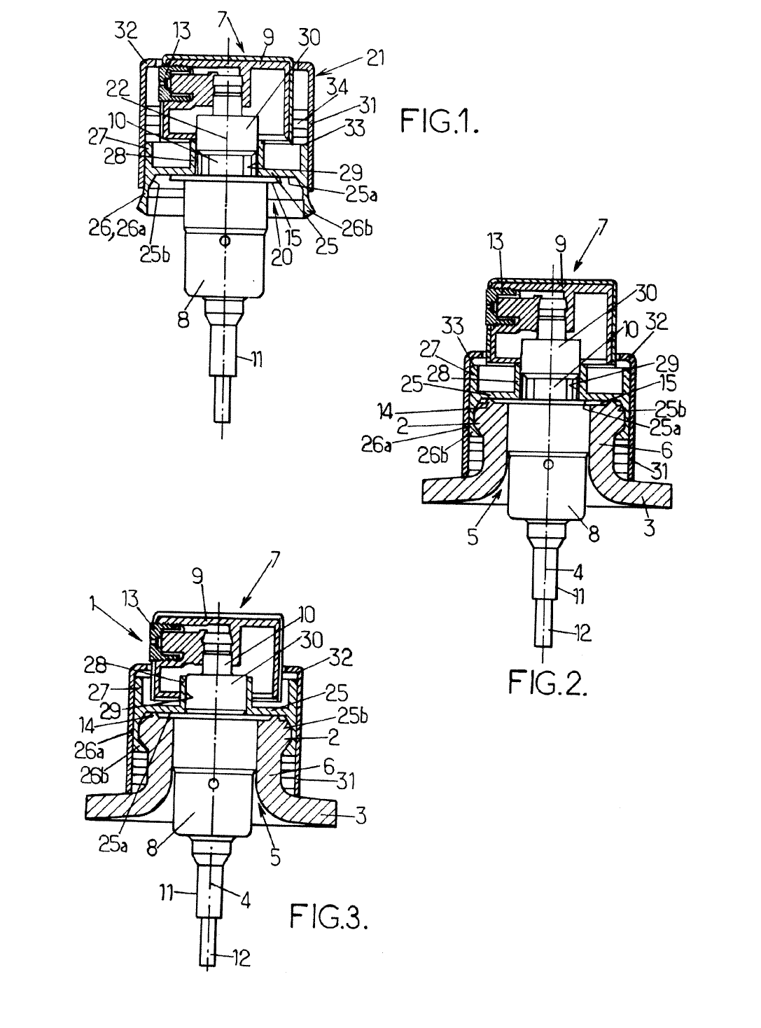

The end portion 26b is movable between a free state represented in FIG. 1, and a deformed state represented in FIGS. 2 and 3.

In the free state, the end portion 26b has an external surface which projects towards the outside in relation to the external surface of the intermediate portion 26a, and an internal surface which does not project towards the inside in relation to the internal surface of the intermediate portion 26a. Provision may be made for the external surface of the end portion in the free state to be inclined or curved with a regular slope or curvature, such that the end portion 26b in the free state may have an external surface of the cam type.

Thus, in FIG. 1, in the free state, the external surface of the end portion 26b may have a diameter strictly greater than the external diameter of the external surface of the intermediate portion 26a. The fastening sleeve 20 then has an external surface which has a flare towards the outside in the vicinity of the end portion 26b.

The internal surface of the end portion 26b may also have a diameter that is substantially constant and greater than the internal diameter of the internal surface of the intermediate portion 26a. Provision may be made, however, for the diameter of the internal surface of the end portion 26b to be equal to the internal diameter of the internal surface of the intermediate portion 26a. Provision may also be made for the diameter of the internal surface of the end portion 26b to increase from a minimum diameter adjacent to the intermediate portion 26a and which is greater than or equal to the internal diameter of the internal surface of the end portion 26b.

In the deformed state, the internal surface of the end portion 26b projects towards the inside in relation to the internal surface of the intermediate portion 26a, and the external surface of the end portion 26b is in axial alignment with the external surface of the intermediate portion 26a.

Thus, in FIGS. 2 and 3, in the deformed state, the external surface of the end portion 26b may have a constant diameter equal to the external diameter of the external surface of the intermediate portion 26a.

The internal surface of the end portion 26b may also have a diameter strictly smaller than the internal diameter of the internal surface of the intermediate portion 26a. The fastening sleeve 20 then has an internal surface which has a restriction towards the inside in the vicinity of the end portion 26b.

The crown 27, which may be continuous or discontinuous, has an external surface that is in axial alignment with the external surface of the intermediate portion 26a of the skirt 26.

As can be seen from the figures, the dispensing device 7 is engaged into the opening 29 of the plate 25 so as to extend substantially along the central axis 22. The internal wall 28 may then be adapted to receive a holder 30 that is integral with the stem 10 of the dispensing device 7 so as to be capable of guiding the displacement of the stem 10. The support zone 25a of the plate 25 rests on the flange 15 of the dispensing device 7.

The skirt 26 of the fastening sleeve 20 may be adapted to entirely accommodate the rim 2. In particular, the skirt may have a dimension according to the central axis 22 that is greater than or equal to the dimension according to the longitudinal axis 4 of the rim 2. The internal surface of the intermediate portion 26a may also have a dimension, measured radially in relation to the central axis 22 of the fastening sleeve 20, i.e. a diameter in the represented example, that is greater than a maximum external dimension, measured radially in relation to the longitudinal axis 4 of the rim 2, i.e. a diameter in the represented example.

The skirt 26 is also adapted to enable, with the end portion 26b in the deformed state, at least a part of the end portion 26b to be arranged beneath the rim 2 to permit the fastening, between the plate 25 and the end portion 26b, of the fastening sleeve 20 to the rim 2.

Thus, when the dispensing device 7 is engaged into the neck 6 for the purpose of its fastening to the neck 6, the support zone 25a of the plate 25 may rest, in an indirect manner by means of the flange 15, on the rim 2. The centring zone 25b may come into tightly sealed peripheral contact with an external edge of the rim 2. And the skirt 26 may be arranged around the rim 2 by covering it.

Such an embodiment, wherein, with the end portion 26b in the free state, no internal surface projects towards the inside, permits to simplify the mounting of the assembly comprising the fastening device and the dispensing device 7 onto the neck 6. This embodiment also makes it possible to avoid the arrangement of the fastening sleeve according to an inappropriate orientation, which would be associated with the risk of trapping the fastening sleeve 20 and/or deforming the fastening sleeve 20 so that the mounting of the retaining ring 21 is rendered impossible. Moreover, the ability of the skirt 26 to have, with the end portion 26b in the free state, an internal surface of which the diameter is greater than the diameter of the rim, permits the risks of trapping to be further restricted. The centring zone 25b also simplifies the positioning and the orientation of the fastening sleeve 20.

In other fastening modes, notably when the body 8 of the dispensing device 7 is without a flange 15 and/or when the body 8 extends into the neck 6 with only partial contact or indeed without any contact, it is possible to provide for the plate 25 and, for example, the internal wall 28 to be adapted to receive the dispensing device 7, for example by a fitting engagement, and, where appropriate, to form a tight seal. The plate 25 may then rest directly on the rim 2, for example on the ring 14. Moreover, the skirt 26 may be adapted to be press fitted with friction against the rim 2 so as to permit the maintaining of the fastening sleeve 20 and the formation of a tight seal between the fastening sleeve 20 and the rim 2.

The retaining ring 21 may comprise an annular lateral wall 31 extending along an axis and an annular border 32 extending radially in relation to the axis of the lateral wall 31, towards the axis, from an end of the lateral wall 31.

The retaining ring 21 is adapted to entirely accommodate the fastening sleeve 20. In particular, the dimension of the retaining ring along the axis of the lateral wall 31 is greater than or equal to the dimension along the central axis 22 of the fastening sleeve 20. Furthermore, the lateral wall 31 has an internal surface adapted to be press fitted with friction on the external surface of the intermediate portion 26a of the skirt 26 and as such with the external surface of the crown 27. In the example, the internal surface of the lateral wall 31 has a diameter that is substantially equal to, or less than although remaining close to, the external diameter of the external surface of the intermediate portion 26a of the skirt 26 and of the crown 27.

In this manner, as represented in FIG. 1, the lateral wall 31 of the retaining ring 21 may be partially press fitted, via its end opposite the border 32, with friction on the external surface of the crown 27, coaxially with the central axis 22, above the end portion 26b of the skirt 26. In this position, the end portion 26b is in the free state. In order to simplify the engagement of the retaining ring 21 on the crown 27, it is possible to provide the crown 27 with a free end having an external chamfer 33.

It is thus possible to form a dispensing assembly comprising the fastening device and the dispensing device 7, and which may be pre-assembled.

Moreover, in order to improve the retention of the retaining ring 20 on the crown 27, one or a plurality of projections 34 may extend substantially perpendicularly from the internal surface of the lateral wall 31 in order to allow engagement with the external surface of the crown 27.

When the retaining ring 20 entirely accommodates the fastening sleeve 21, as represented in FIGS. 2 and 3, the lateral wall 31 is press fitted with friction on the entire external surface of the fastening sleeve 20, i.e. the external surfaces of the crown 27 and of the intermediate 26a and end 26b portions, the end portion 26b being in the deformed state and the projections 34 engaging the external surface of the intermediate portion 26a of the skirt 26.

The border 32 may delimit an opening permitting the passage of the actuator 9. Furthermore, the dimension of the lateral wall 31, measured along the axis of the retaining ring 21, may be provided in order for said lateral wall 31 to be capable of coming to a stop against the container 3.

With reference to the figures, there now follows a description of a method of assembling a dispenser as described above.

The container 3 and the pre-assembled dispensing assembly represented in FIG. 1, and wherein the stem 10 of the dispensing device 7 is engaged in the opening 29 of the fastening sleeve 20, are provided, the support zone 25a of the plate 25 resting on the flange 15 of the body 8, and the retaining ring 21 being press fitted with friction on the crown 27 above the end portion 26b in the free state.

The pre-assembled dispensing assembly is positioned onto the neck 6 of the container in such a way that the central axis 22 of the fastening sleeve 20 extends substantially coaxially with the longitudinal axis 4 of the neck 6. In this position, the dispensing device 7 extends into the neck 6, the flange 15, on which the plate 25 rests, rests on the rim 2, the skirt 26 entirely accommodates the rim 2, and the retaining ring 21 is partially press fitted with friction on the external surface of the crown 27, above the end portion 26b of the skirt 26, said end portion 26b in the free state projecting towards the outside.

An external force acting in the longitudinal axis 4 is then applied to the retaining ring 21, toward the neck 6, so as to displace the retaining ring 21 in relation to the fastening sleeve 20. In the course of its displacement, the retaining ring 21 slides along the external surfaces of the crown 27 and of the intermediate portion 26a and then encounters the external surface of the end portion 26b. As it slides over the external surface of the end portion 26b, the retaining ring 21 deforms and pushes against the end portion 26b until it entirely accommodates the fastening sleeve 20. In this way, the retaining ring 21 causes the end portion 26b of the skirt 26 to pass from the free state to the deformed state, in which the internal surface of the end portion 26b extends at least partially beneath the rim in order to fasten the fastening sleeve to the rim 2 between the plate 25 and the end portion 26b.

1. Fastening device for fastening a dispensing device to a container comprising a tubular neck, said fastening device comprising:
a fastening sleeve comprising:
an annular plate centred on a central axis and extending along a radial plane in relation to the central axis,
an annular skirt which extends axially from the plate, centred on the central axis, and which has a cylindrical intermediate portion adjacent to the plate and an end portion remote from the plate, said intermediate portion having an internal surface and an external surface, said end portion comprising an internal surface and an external surface, said end portion being movable between:
a free state, in which the external surface of said end portion projects towards the outside in relation to the external surface of the intermediate portion, and the internal surface of said end portion does not project towards the inside in relation to the internal surface of the intermediate portion, and
a deformed state, in which the internal surface of said end portion projects towards the inside in relation to the internal surface of the intermediate portion, and the external surface of said end portion is in axial alignment with the external surface of the intermediate portion,
a retaining ring adapted to entirely accommodate the fastening sleeve and having an internal surface adapted to be press fitted with friction on the external surface of the intermediate portion of the skirt,
said fastening device being characterized in that the fastening sleeve further comprises a crown which extends axially from the plate opposite the skirt, said crown having an external surface that is in axial alignment with the external surface of the intermediate portion of the skirt.

2. Fastening device according to claim 1, wherein the plate has a lower surface which comprises a support zone, situated centrally, and a centring zone, situated peripherally, linking said support zone to the internal surface of the intermediate portion of the skirt, said centring zone being flared from said support surface toward said internal surface of the intermediate portion.

3. Fastening device according to claim 1, comprising at least one projection which extends substantially perpendicularly from the internal surface of the retaining ring, and which is adapted to enable engagement with the external surface of the intermediate portion of the skirt.

4. Fastening device according to claim 1, wherein the crown comprises a free end having an external chamfer.

5. Fastening device according to claim 1, being globally cylindrical of revolution about the central axis.

6. Dispensing assembly comprising a fastening device according to claim 1 and a dispensing device, the annular plate delimiting an opening centred on the central axis, and into which the dispensing device is mounted so as to extend substantially along the central axis.

7. Dispensing assembly according to claim 6, wherein the retaining ring is partially press fitted with friction on the external surface of the crown, above the end portion of the skirt, said end portion being in the free state.

8. Dispensing assembly according to claim 6, wherein the fastening sleeve comprises an annular internal wall, which extends axially from the plate and which is adapted to receive the dispensing device with a fitting engagement.

9. Dispensing assembly according to any of claim 6, wherein the dispensing device comprises a cylindrical body extending along an axis and provided with a radial flange in relation to the axis of the body, the annular plate resting on the flange.

10. Dispenser comprising a dispensing assembly according to claim 6 and a container, which container comprises a tubular neck extending along a longitudinal axis, of which a free end is provided with a rim projecting radially in relation to the longitudinal axis, which neck is adapted to enable the dispensing device to extend into the neck, the skirt of the fastening sleeve being adapted to entirely accommodate the rim, and, in the deformed state of the end portion of the skirt, to enable at least one part of said end portion to be arranged beneath the rim.

11. Dispenser according to claim 10, wherein the internal surface of the intermediate portion of the skirt has a dimension, measured radially in relation to the central axis of the fastening sleeve, that is greater than a maximum external dimension of the rim, measured radially in relation to the longitudinal axis.

12. Dispenser according to claims 10, wherein the neck is adapted to enable the dispensing device to be press fitted with friction into the neck.

13. Dispenser according to claim 10, wherein the dispensing device extends into the neck, the plate resting on the rim, the skirt entirely accommodating the rim, the retaining ring entirely accommodating the fastening sleeve, the end portion of the skirt being in the deformed state so that at least one part of said end portion is arranged beneath the rim.

14. Method of assembling a dispenser according to claim 13, said method providing for the following steps, starting from a container comprising a tubular neck extending along a longitudinal axis, of which a free end is provided with a rim projecting radially in relation to the longitudinal axis, and from a dispensing assembly according to claim 6:
position the dispensing assembly on the neck so that the central axis of the fastening sleeve extends substantially coaxially with the longitudinal axis of the neck, the dispensing device extending into the neck, the plate resting on the rim, the skirt entirely accommodating the rim, the retaining ring being partially press fitted with friction on the external surface of the crown, above the end portion of the skirt, said end portion being in the free state,
exert an external force on the retaining ring along the longitudinal axis, toward the neck, so as to displace the retaining ring in relation to the fastening sleeve until said retaining ring entirely accommodates said fastening sleeve, the retaining ring causing the end portion of the skirt to pass from the free state to the deformed state.
